(19) United States
(12) Patent Application Publication
(10) Pub. No.: US 2016/0381292 A1
(43) Pub. Date: Dec. 29, 2016

(54) Dash cam

(71) Applicant: 4Sight, Inc., Ontario, CA (US)

(72) Inventor: Jacky Lu, Ontario, CA (US)

(73) Assignee: 4Sight, Inc.

(21) Appl. No.: 15/259,049

(22) Filed: Sep. 8, 2016

(51) Int. Cl. H04N 5/232; H04N 5/33; G06F 3/16; B60R 1/00

(52) U.S. Cl. CPC H04N 5/23238; B60R 1/00; H04N 5/33; G06F 3/16; B60R 2300/106; B60R 2300/50; B60R 2300/40; B60R 2300/8006

(57) ABSTRACT

A dash cam includes: a body; a first lens mounted on a front portion of the body; a rotatable holder mounted on a bottom portion of the body, wherein the rotatable holder horizontally rotates; a second lens mounted on the rotatable holder, so as to horizontally rotates with the rotatable holder; a processor mounted inside the body and respectively connected to the first lens and the second lens, wherein the processor receives data from the first lens and the second lens; a storage connected to the processor, for storing the data received by the processor; and a power source connected to the processor, for supplying the dash cam. The first lens is fixed and the second lens is rotatable by 320 degrees, in such a manner that the two wide-angle lenses are able to capture everything happening inside and outside the vehicle.

### BACKGROUND OF THE PRESENT INVENTION

Field of Invention

The present invention relates to a technical field of drive recording, and more particularly to a dash cam.

Description of Related Arts

A dash cam or a dashboard camera is an onboard camera that continuously records the view through a vehicle's windscreen. It may be attached to the interior windscreen or to the top of the dashboard, by suction cup or adhesive-tape mount. Dash cams may provide video evidence in the event of an accident.

Dash cams are gaining in popularity in many parts of Asia, Europe (particularly in France), Australia and the US. Dash cams are widespread in Russia as a guard against police corruption and insurance fraud, where they provide additional evidence. Thousands of videos showing automobile and aircraft crashes, close calls, and attempts at insurance fraud have been uploaded to social interactive and sharing websites such as YouTube, Facebook, Twitter and other websites. Police departments use dash cams in police vehicles to gather evidence during traffic stops and car chases. Some dash cam systems can be automatically activated when a police car's emergency lights or siren are turned on. Freedom of information laws mean that the footage can be released under some circumstances, and this can be an important tool in reporting on police actions. TV shows like World's Wildest Police Videos have frequently featured car chase videos shot from dash cams.

Various types of dash cams are available on the market, ranging from basic video cameras to ones which also record parameters such as date/time, speed, G-forces and location. However, all these dash cams put emphasis on capturing what is happening outside a vehicle. Therefore, wonderful moments inside the vehicle, especially during self-driving travelling involving family members or friends, are ignored.

According to market research, requirement for capturing everything happening inside and outside the vehicle is growing, which illustrates a great market potential.

### SUMMARY OF THE PRESENT INVENTION

An object of the present invention is to provide a dash cam for capturing everything happening inside and outside a vehicle.

Another object of the present invention is to provide a dash cam which locks files on a sudden impact.

Accordingly, in order to accomplish the above objects, the present invention provides a dash cam, comprising:

a body (1);

a first lens (2) mounted on a front portion of the body (1);

a rotatable holder (3) mounted on a bottom portion of the body (1), wherein the rotatable holder (3) horizontally rotates;

a second lens (4) mounted on the rotatable holder (3), so as to horizontally rotates with the rotatable holder;

a processor (5) mounted inside the body (1) and respectively connected to the first lens (2) and the second lens (4), wherein the processor (5) receives data from the first lens (2) and the second lens (4);

a storage (6) connected to the processor (5), for storing the data received by the processor; and

a power source (11) connected to the processor (5), for supplying the dash cam.

The dash cam further comprises: an infrared module (7), wherein the infrared module (7) is arranged around the first lens (2) for assisting the first lens (2) to image in a dark environment.

The dash cam further comprises: a panel provided on a rear portion of the body and connected to the processor (5), wherein the panel comprises a displayer (8) and buttons (9), so as to set and display parameters of the dash cam, or display the data stored in the storage (6).

The dash cam further comprises: an accelerometer (10) connected to the processor (5), wherein when the accelerometer (10) detects an accelerated velocity which is larger than a pre-set value, a signal is generated by the accelerometer (10) and sent to the processor (5), in such a manner that the processor (5) cut off power supply of the storage for protecting the data stored.

The dash cam further comprises: a microphone (12) mounted on a surface of the body (1) and connected to the processor, wherein sound data captured by the microphone (12) is sent to the processor, so as to be stored in the storage (6).

The dash cam further comprises: a data transmitter (17) connected to the processor (5), wherein the data transmitter (17) reads the data through the processor (5) and transmits the data to a user terminal (19).

The data transmitter (17) comprises a transmitting terminal (14) arranged on a surface of the body (1), in such a manner that the user terminal (19) is connected to the transmitting terminal (14) by inserting a cable (18) into the transmitting terminal (14) for transmitting the data.

The data transmitter (17) has a wireless function for transmitting the data to the user terminal (19) through a wireless network.

The storage (6) is inserted into the body (1) from a storage port (13) on the body (1), and is detachable from the storage port (13).

The dash cam further comprises: a connector (15) mounted on a top portion of the body (1), for mounting a supporter (16) on the body through the connector (15).

The first lens (2) and the second lens (4) are wide-angle lenses.

A rotatable range of the second lens (4) is 320 degrees.

Therefore, with the foregoing structure, the first lens (2) is fixed and the second lens (4) is rotatable by 320 degrees, in such a manner that the two wide-angle lenses are able to capture everything happening inside and outside the vehicle. Particularly, the first lens (2) faces towards a driving direction, for recording views through a vehicle windscreen. The second lens (4) is mainly arranged backwards the driving direction, for recording views inside the vehicle. The second lens (4) may also be arranged towards the driving direction for assisting the first lens (2), or be arranged towards a side of the vehicle, for recording side views of the vehicle through side windows, so as to provide video evidences for side crash or other accidents. Furthermore, during an accident, the accelerometer (10) will generate the signal after detecting a large G-force, and send the signal to the processor (5), in such a manner that the data in the storage (6) are locked on sudden impact. With the infrared module (7), the dash cam of the present invention is capable of night recording, which enhances recording performance in the dark environment.

These and other objectives, features, and advantages of the present invention will become apparent from the following detailed description, the accompanying drawings, and the appended claims.

### BRIEF DESCRIPTION OF THE DRAWINGS

FIG. 1 is a front view of a dash cam according to a preferred embodiment 1 of the present invention.

FIG. 2 is a rear view of the dash cam according to the preferred embodiment 1 of the present invention.

FIG. 3 is a left view of the dash cam according to the preferred embodiment 1 of the present invention.

FIG. 4 is a right view of the dash cam according to the preferred embodiment 1 of the present invention.

FIG. 5 is a top view of the dash cam according to the preferred embodiment 1 of the present invention.

FIG. 6 is a bottom view of the dash cam according to the preferred embodiment 1 of the present invention.

FIG. 7 is a sectional view of the dash cam according to the preferred embodiment 1 of the present invention.

FIG. 8 is a schematic view of the dash cam according to the preferred embodiment 1 of the present invention.

FIG. 9 is a perspective view of the dash cam with a supporter according to the preferred embodiment 1 of the present invention.

FIG. 10 illustrates a displaying effect of a displayer of the dash cam according to the preferred embodiment 1 of the present invention.

FIG. 11 illustrates an installation of the dash cam according to the preferred embodiment 1 of the present invention.

FIG. 12 illustrates a communication between the dash cam and a user terminal through a cable according to the preferred embodiment 1 of the present invention.

FIG. 13 illustrates a communication between the dash cam and the user terminal through a wireless network according to the preferred embodiment 1 of the present invention.

FIG. 14 is a front view the dash cam according to a preferred embodiment 2 of the present invention.

FIG. 15 is a rear view of the dash cam according to the preferred embodiment 2 of the present invention.

FIG. 16 is a left view of the dash cam according to the preferred embodiment 2 of the present invention.

FIG. 17 is a right view of the dash cam according to the preferred embodiment 2 of the present invention.

FIG. 18 is a top view of the dash cam according to the preferred embodiment 2 of the present invention.

FIG. 19 is a bottom view of the dash cam according to the preferred embodiment 2 of the present invention.

### DETAILED DESCRIPTION OF THE PREFERRED EMBODIMENT

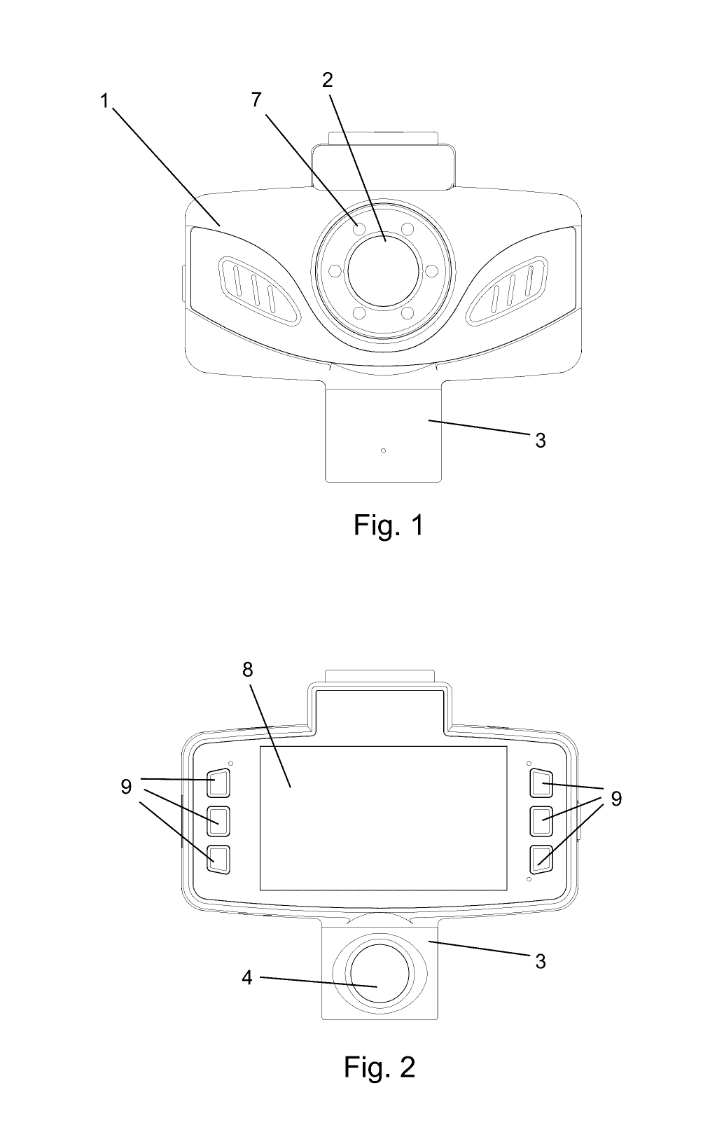

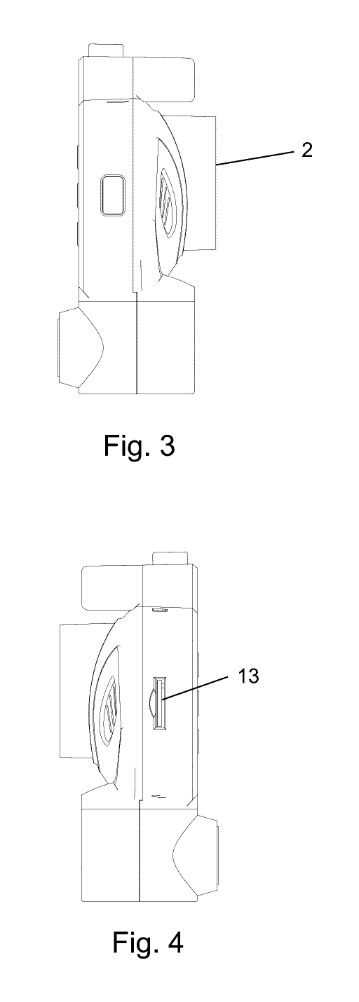

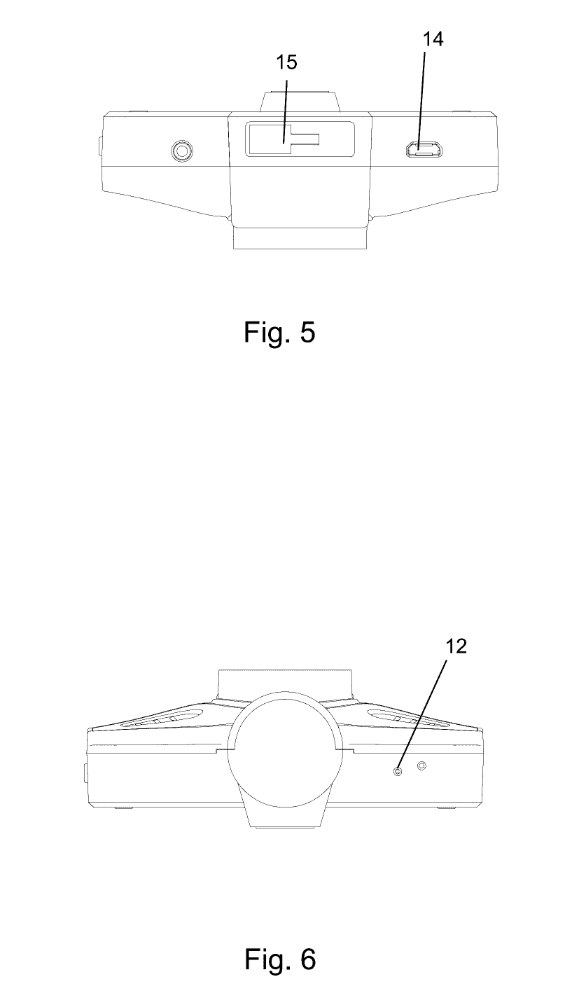

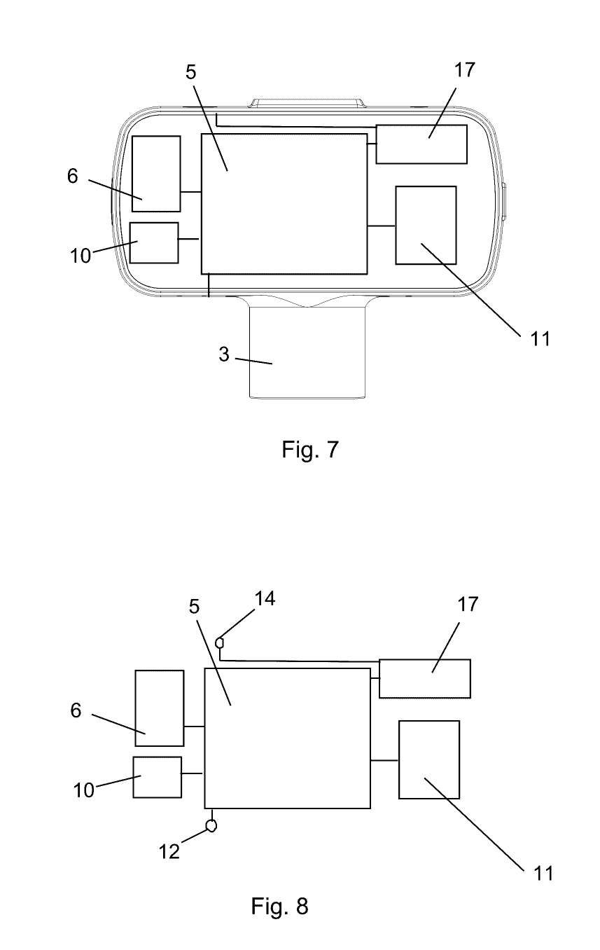

Referring to FIGS. 1-8 of the drawings, a dash cam according to a preferred embodiment 1 of the present invention is illustrated, comprising

a body 1;

a first lens 2 mounted on a front portion of the body 1;

a rotatable holder 3 mounted on a bottom portion of the body 1, wherein the rotatable holder 3 horizontally rotates;

a second lens 4 mounted on the rotatable holder 3, so as to horizontally rotates with the rotatable holder;

a processor 5 mounted inside the body 1 and respectively connected to the first lens 2 and the second lens 4, wherein the processor 5 receives data from the first lens 2 and the second lens 4;

a storage 6 connected to the processor 5, for storing the data received by the processor; and

a power source 11 connected to the processor 5, for supplying the dash cam.

Preferably, the dash cam further comprises: an infrared module 7, wherein the infrared module 7 is arranged around the first lens 2 for assisting the first lens 2 to image in a dark environment.

Preferably, the dash cam further comprises: a panel provided on a rear portion of the body and connected to the processor 5, wherein the panel comprises a displayer 8 and buttons 9, so as to set and display parameters of the dash cam, or display the data stored in the storage 6.

Preferably, the dash cam further comprises: an accelerometer 10 connected to the processor 5, wherein when the accelerometer 10 detects an accelerated velocity which is larger than a pre-set value, a signal is generated by the accelerometer 10 and sent to the processor 5, in such a manner that the processor 5 cut off power supply of the storage for protecting the data stored.

Preferably, the dash cam further comprises: a microphone 12 mounted on a surface of the body 1 and connected to the processor, wherein sound data captured by the microphone 12 is sent to the processor, so as to be stored in the storage 6.

Preferably, the dash cam further comprises: a data transmitter 17 connected to the processor 5, wherein the data transmitter 17 reads the data through the processor 5 and transmits the data to a user terminal 19.

Preferably, the data transmitter 17 comprises a transmitting terminal 14 arranged on a surface of the body 1, in such a manner that the user terminal 19 is connected to the transmitting terminal 14 by inserting a cable 18 into the transmitting terminal 14 for transmitting the data.

Preferably, the data transmitter 17 has a wireless function for transmitting the data to the user terminal 19 through a wireless network.

Preferably, the storage 6 is inserted into the body 1 from a storage port 13 on the body 1, and is detachable from the storage port 13.

Preferably, the dash cam further comprises: a connector 15 mounted on a top portion of the body 1, for mounting a supporter 16 on the body through the connector 15.

Preferably, the first lens 2 and the second lens 4 are wide-angle lenses.

Preferably, a rotatable range of the second lens 4 is 320 degrees.

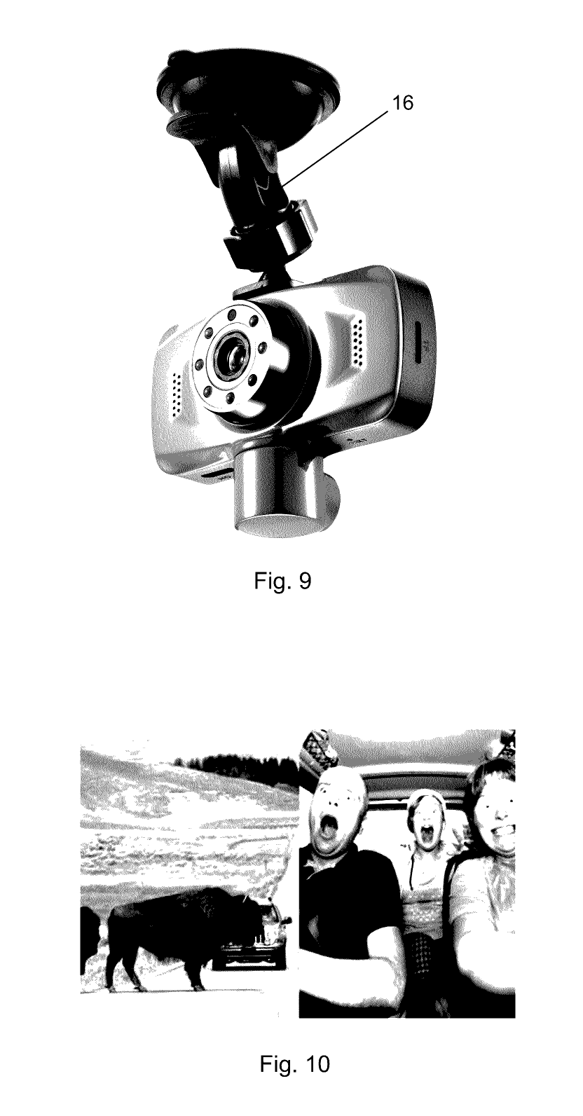

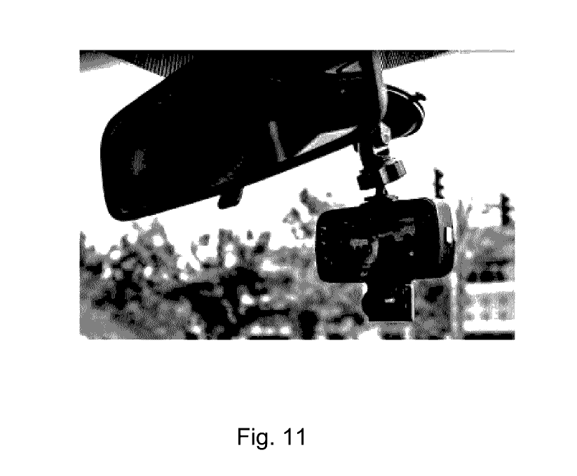

Referring to FIG. 9, the supporter 16 is connected to the body 1, and the second lens 4 is turned backs a driving direction, wherein during working, views of both lenses are displayed onto the displayer 8 in a split type as shown in FIG. 10, and an installation position in the vehicle is shown in FIG. 11. Referring to FIG. 11, the dash cam is installed near the rear view mirror, at the center and top of windshield (must follow all local laws related to mounted devices in vehicle).

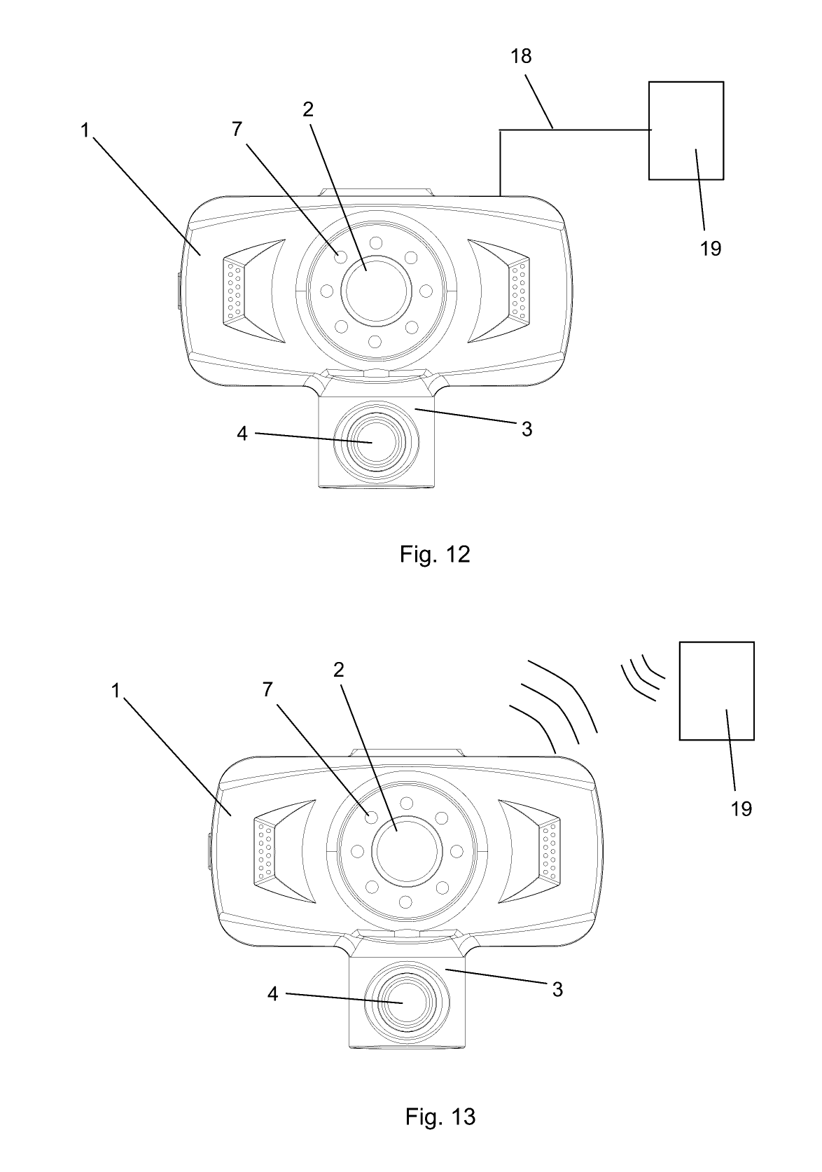

Both the first lens 2 and the second lens 4 record videos in HD 1080p onto a micro SD card which is used as the storage 6. The micro SD card is detachable from the dash cam through the storage port 13, and the date stored is readable by a computer or other reading devices. The dash cam may also directly communicate with the user terminal 19, i.e. the computer or a mobile phone. Referring to FIG. 12, the dash cam is connected to the user terminal 19 through the cable 18 which may be a USB cable, a HDMI cable, a Thunderbolt cable or other suitable cables corresponding to the transmitting terminal 14. Referring to the FIG. 13, the dash cam communicates with the user terminal 19 through the wireless network which may be a Bluetooth network or a WIFI network.

Therefore, with the foregoing structure, the first lens 2 is fixed and the second lens 4 is rotatable by 320 degrees, in such a manner that the two wide-angle lenses are able to capture everything happening inside and outside the vehicle. Particularly, the first lens 2 faces towards a driving direction, for recording views through a vehicle windscreen. The second lens 4 is mainly arranged backwards the driving direction, for recording views inside the vehicle. The second lens 4 may also be arranged towards the driving direction for assisting the first lens 2, or be arranged towards a side of the vehicle, for recording side views of the vehicle through side windows, so as to provide video evidences for side crash or other accidents. Furthermore, during an accident, the accelerometer 10 will generate the signal after detecting a large G-force, and send the signal to the processor 5, in such a manner that the data in the storage 6 are locked on sudden impact. With the infrared module 7, the dash cam of the present invention is capable of night recording, which enhances recording performance in the dark environment.

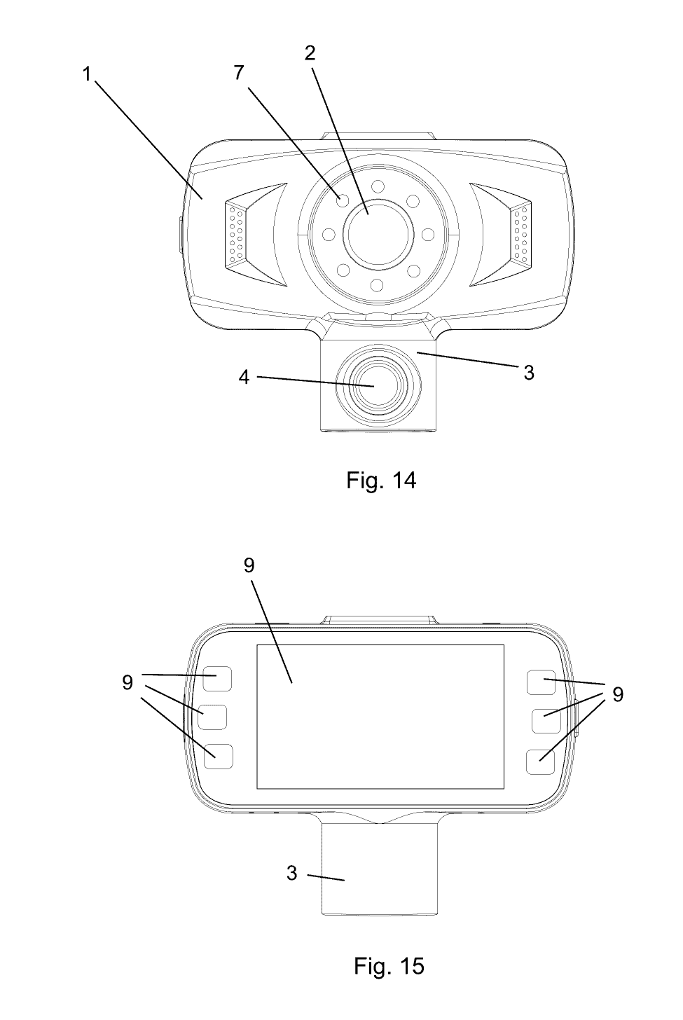

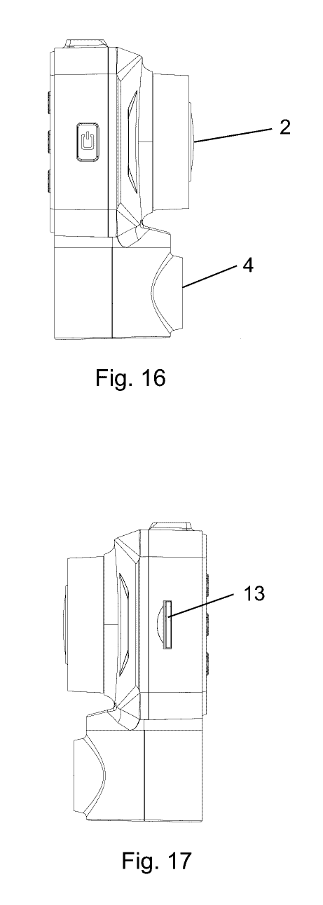

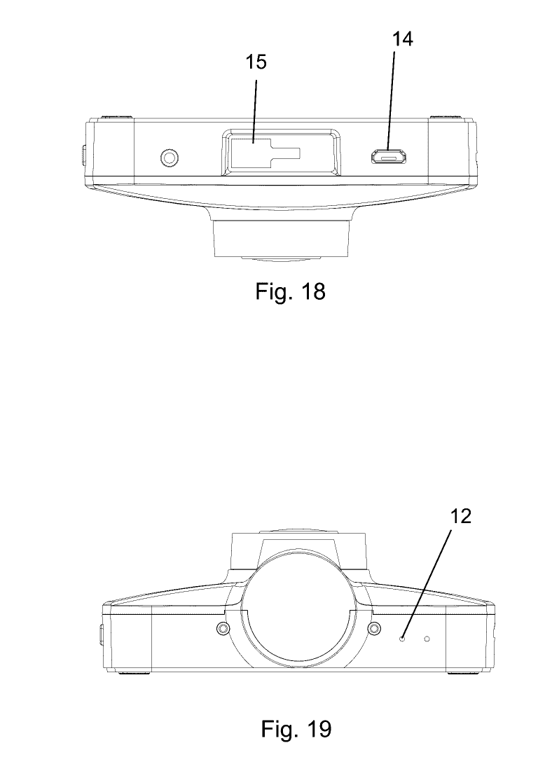

Referring to FIGS. 14-19 of the drawings, a dash cam according to a preferred embodiment 2 of the present invention is illustrated. The preferred embodiment 2 provides an alternative appearance design without function change.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A dash cam, comprising:
a body (1);
a first lens (2) mounted on a front portion of the body (1);
a rotatable holder (3) mounted on a bottom portion of the body (1), wherein the rotatable holder (3) horizontally rotates;
a second lens (4) mounted on the rotatable holder (3), so as to horizontally rotates with the rotatable holder;
a processor (5) mounted inside the body (1) and respectively connected to the first lens (2) and the second lens (4), wherein the processor (5) receives data from the first lens (2) and the second lens (4);
a storage (6) connected to the processor (5), for storing the data received by the processor; and
a power source (11) connected to the processor (5), for supplying the dash cam.

2. The dash cam, as recited in claim 1, further comprising: an infrared module (7), wherein the infrared module (7) is arranged around the first lens (2) for assisting the first lens (2) to image in a dark environment.

3. The dash cam, as recited in claim 1, further comprising: a panel provided on a rear portion of the body and connected to the processor (5), wherein the panel comprises a displayer (8) and buttons (9), so as to set and display parameters of the dash cam, or display the data stored in the storage (6).

4. The dash cam, as recited in claim 1, further comprising: an accelerometer (10) connected to the processor (5), wherein when the accelerometer (10) detects an accelerated velocity which is larger than a pre-set value, a signal is generated by the accelerometer (10) and sent to the processor (5), in such a manner that the processor (5) cut off power supply of the storage for protecting the data stored.

5. The dash cam, as recited in claim 1, further comprising: a microphone (12) mounted on a surface of the body (1) and connected to the processor, wherein sound data captured by the microphone (12) is sent to the processor, so as to be stored in the storage (6).

6. The dash cam, as recited in claim 1, further comprising: a data transmitter (17) connected to the processor (5), wherein the data transmitter (17) reads the data through the processor (5) and transmits the data to a user terminal (19).

7. The dash cam, as recited in claim 6, wherein the data transmitter (17) comprises a transmitting terminal (14) arranged on a surface of the body (1), in such a manner that the user terminal (19) is connected to the transmitting terminal (14) by inserting a cable (18) into the transmitting terminal (14) for transmitting the data.

8. The dash cam, as recited in claim 6, wherein the data transmitter (17) has a wireless function for transmitting the data to the user terminal (19) through a wireless network.

9. The dash cam, as recited in claim 1, wherein the storage (6) is inserted into the body (1) from a storage port (13) on the body (1), and is detachable from the storage port (13).

10. The dash cam, as recited in claim 1, further comprising: a connector (15) mounted on a top portion of the body (1), for mounting a supporter (16) on the body through the connector (15).

11. The dash cam, as recited in claim 1, wherein the first lens (2) and the second lens (4) are wide-angle lenses.

12. The dash cam, as recited in claim 1, wherein a rotatable range of the second lens (4) is 320 degrees.

13. The dash cam, as recited in claim 2, further comprising: a panel provided on a rear portion of the body and connected to the processor (5), wherein the panel comprises a displayer (8) and buttons (9), so as to set and display parameters of the dash cam, or display the data stored in the storage (6).

14. The dash cam, as recited in claim 13, further comprising: an accelerometer (10) connected to the processor (5), wherein when the accelerometer (10) detects an accelerated velocity which is larger than a pre-set value, a signal is generated by the accelerometer (10) and sent to the processor (5), in such a manner that the processor (5) cut off power supply of the storage for protecting the data stored.

15. The dash cam, as recited in claim 14, further comprising: a microphone (12) mounted on a surface of the body (1) and connected to the processor, wherein sound data captured by the microphone (12) is sent to the processor, so as to be stored in the storage (6).

16. The dash cam, as recited in claim 15, further comprising: a data transmitter (17) connected to the processor (5), wherein the data transmitter (17) reads the data through the processor (5) and transmits the data to a user terminal (19).

17. The dash cam, as recited in claim 16, wherein the data transmitter (17) comprises a transmitting terminal (14) arranged on the surface of the body (1), in such a manner that the user terminal (19) is connected to the transmitting terminal (14) by inserting a cable (18) into the transmitting terminal (14) for transmitting the data.

18. The dash cam, as recited in claim 17, wherein the data transmitter (17) has a wireless function for transmitting the data to the user terminal (19) through a wireless network.

19. The dash cam, as recited in claim 18, wherein the storage (6) is inserted into the body (1) from a storage port (13) on the body (1), and is detachable from the storage port (13).

20. The dash cam, as recited in claim 19, further comprising: a connector (15) mounted on a top portion of the body (1), for mounting a supporter (16) on the body through the connector (15).
